(19) United States
(12) Patent Application Publication
(10) Pub. No.: US 2024/0290195 A1
(43) Pub. Date: Aug. 29, 2024

(54) Item of Clothing with Emergency Alarms

(71) Applicant: Nadine HUCK, Ludwigshafen (DE)

(72) Inventor: Dennis HUCK, Diez (DE)

(21) Appl. No.: 17/769,393

(22) PCT Filed: Oct. 16, 2020
(86) PCT No.: PCT/EP2020/079223

§ 371 Date: Jun. 13, 2023

(30) Foreign Application Priority Data
Oct. 17, 2019 (LU) LU101441

(51) Int. Cl. G08B 25/00; G08B 25/01

(52) U.S. Cl. CPC G08B 25/001; G08B 25/016

(57) ABSTRACT

The invention relates to an item of clothing having at least one sensor, which transfers sensor signals to a control apparatus, and a telecommunication device. The item of clothing is distinguished by the fact that the control apparatus continuously evaluates the sensor signals and assigns the latter either to a normal situation or to an emergency situation, and by the fact that, in the event of an emergency situation, the control apparatus uses the telecommunication device to send an emergency call and/or to establish a telecommunication connection automatically and with a predetermined or predeterminable time delay, unless the control apparatus receives, within the time delay, an abort signal that can be triggered by the person wearing the item of clothing.

The invention relates to an item of clothing that comprises at least one sensor, which delivers sensor signals to a control apparatus, and a telecommunication device.

In everyday life, people get into emergency situations from time to time, for example due to an accident or as a result of a violent attack, which means that it is necessary to make an emergency call.

The German patent application DE 101 33 523 A1 discloses a technical device that enables persons who are under threat to trigger an alarm, in an emergency, that startles the attacker and that activates an emergency call to the police or to a similar facility, the apparatus also being able to indicate the position of the person who is in danger. The device comprises an activation button that may be worn disguised in an item of jewelry or a wristband, as an attachment on a belt. However, this device disadvantageously works only if the person who is under threat is still capable of triggering the alarm himself.

Those in need often have no way of making an emergency call. This may be because they become unconscious due to an accident, for example. Particularly in the case of sports accidents, as may occur for example when hiking, cycling, skiing, mountain biking or climbing, it often happens that the persons involved in an accident are not missed and found until after a fairly long time. Another occurrence is that people are prevented from making an emergency call by an attacker in the event of a violent mugging, for example. In particular, a mugging often involves the victims immediately having their cell phones taken and/or the victims being tied up and/or injured.

U.S. Pat. No. 6,388,422 B1 discloses a jacket for military purposes that comprises sensors and power sources and that can transmit battlefield information to the headquarters. External electronic devices and various types of sensors may be connected and supplied with power by way of one or more sockets integrated in the material. An antenna that is likewise integrated in the material allows communication with other wearers of such a jacket and with command and control centers on the ground or in the air and with remote headquarters via satellite. A similar item of clothing is known from WO 2011 092 553 A1. The item of clothing is designed for guards and patrols and comprises electronic apparatuses for a radio connection to an operations center.

However, these apparatuses are reliant on a specially equipped operations center being constantly available that assesses the received information. Such items of clothing thus cannot be usefully employed for private use, because it is not always reasonable for any trusted person, for example a parent, to continually monitor and assess the information transmitted by an item of clothing that is worn by a child at play, for example.

It is thus the object of the present invention to specify a way of allowing an emergency situation to be reliably communicated.

The object is achieved by an item of clothing of the type cited at the outset that is characterized in that the control apparatus continually evaluates the sensor signals and attributes them either to a normal situation or to an emergency situation, in particular a criminal act, and in that, in the event of an emergency situation, the control apparatus, automatically and with a predetermined or predeterminable time delay, uses the telecommunication device to transmit an emergency call and/or to establish a telecommunication connection, unless the control apparatus receives, within the time delay, an abort signal triggerable by the wearer of the item of clothing.

The invention has the quite particular advantage that it may in particular also feasibly be employed by private individuals in everyday life. This is advantageously achieved firstly by virtue of a false alarm being able to be prevented by the wearer of the item of clothing within the predefined or predefinable period of time, for example 20 seconds, which protects the person who is intended to receive an emergency call or as the other party for setup of a telecommunication connection from unnecessary disturbances. Secondly, there is still the assurance that an emergency call is made or a telecommunication connection is established reliably even if the wearer of the item of clothing is himself no longer capable of acting.

The item of clothing may in particular be designed to identify a criminal act, such as for example an assault and/or an abduction situation.

As will be explained in detail later, the item of clothing may comprise as the sensor a force sensor, for example, that detects, in particular quantitatively, actions of force on the item of clothing. If for example a person wearing such an item of clothing is physically attacked, the control apparatus will receive from the force sensor a sensor signal that may be attributed to an action of force that is above a previously stipulated or stipulable threshold. In this case, the control apparatus will use the telecommunication device to make an emergency call, for example to the cell phone of the mother, and/or to establish a telecommunication connection to a previously stipulated or stipulable terminal, for example the cell phone of the mother, as soon as the time delay has elapsed. In particular, there may advantageously be provision in this case for the established telecommunication connection to permit further information, in particular optical information recorded by a sensor in the form of a camera, or acoustic information recorded by a sensor in the form of a microphone, or position information produced by a sensor in the form of a GPS position sensor, to be transmitted, in particular live, to the remote station of the telecommunication connection, for example the cell phone of the mother.

In a quite particularly advantageous embodiment, the control apparatus stores the sensor signals that it receives within the delay time and sends these sensor signals preferably together with the emergency call and/or via the established telecommunication connection. This embodiment provides the wearer of the item of clothing with the opportunity to communicate what has happened, or what is happening, to the recipient of the emergency call and/or the remote station of the telecommunication connection. By way of example, the wearer of the item of clothing can say what has happened and/or is happening, the statement being detected by an acoustic sensor and then being transmitted by the control apparatus to the recipient of the emergency call and/or to the remote station of the telecommunication connection as a voice message.

Should the person wearing the item of clothing merely have bumped into a door or a lamppost, for example, by accident and without consequences, however, he is himself able to trigger an abort signal, for example by pushing an electrical pushbutton switch, which is preferably mounted in a hidden manner. In this case, an emergency call is not made and a telecommunication connection is not established.

In particular, there may advantageously be provision for the item of clothing to notify the wearer if the control apparatus has detected a supposed emergency situation and therefore the delay time before an emergency call is transmitted and/or before a telecommunication connection is established has begun to run. Preferably, the item of clothing notifies the wearer of the detection of an emergency situation secretly so that possible attackers are not shown how to trigger the abort signal themselves. By way of example, the notification may be provided by virtue of the control apparatus activating a vibration apparatus integrated in the item of clothing.

In a quite particularly advantageous embodiment, an input apparatus for inputting the abort signal is present.

The input apparatus may be in the form of an electrical switch or in the form of an electrical pushbutton switch, for example. In particular, such a switch or pushbutton switch may be arranged in a pocket of the item of clothing. It is alternatively also possible for the switch or pushbutton switch to be arranged in a hidden manner, for example in an inner lining of the item of clothing.

In another embodiment, the input apparatus is in the form of a microphone. In the case of such an embodiment, the control apparatus may advantageously be in the form of a voice recognition module. In particular, the control apparatus may be designed to identify whether a previously stipulated abort password, such as for example “abort”, has been given. In particular, there may be provision for example for the control apparatus to receive electrical signals from the microphone and to compare said electrical signals with the signals stored in a memory in order to determine whether a previously stipulated abort password has been given.

Preferably, the input apparatus is arranged in a concealed and/or invisible manner. This advantageously prevents the abort signal from being triggered by unauthorized third parties.

In a quite particularly advantageous embodiment, the at least one sensor simultaneously acts as the input apparatus for triggering the abort signal. By way of example, the sensor may be in the form of an acoustic sensor, with the control apparatus continually examining whether specific keywords suggesting an emergency, such as for example the word “help”, are spoken. This sensor may simultaneously also act as the input apparatus for triggering the abort signal by virtue of the control apparatus ascertaining whether a previously stipulated abort password, for example “abort”, has been given.

In a particularly advantageous embodiment, the sensor is a force sensor that detects forces exerted on the item of clothing. Such an embodiment has the quite particular advantage that it may reliably be determined whether the wearer of the item of clothing is subject to unusually large forces, for example as a result of a violent attack or as a result of an accident. In particular, multiple force sensors may advantageously be present.

By way of example, force sensors, in particular tensile force sensors, may be arranged in the sleeves of an item of clothing according to the invention that is in the form of a jacket or in the form of a pullover or in the form of a coat or in the form of a shirt, or in the trouser legs of an item of clothing according to the invention that is in the form of trousers. In this way, it may in particular be determined whether at least one of the sleeves or at least one trouser leg is pulled, for example in a physical argument.

In a quite particularly advantageous version of an embodiment of the item of clothing that is in the form of an item of upper body clothing, such as for example a jacket, a coat, a pullover or a shirt, the sleeves and the back area both comprise at least one sensor, in particular force sensor, each. Additionally, the chest area of the item of clothing may advantageously also comprise, advantageously, at least one sensor, in particular force sensor.

In a quite particularly advantageous embodiment of an item of clothing in the form of trousers, the trouser legs and the seat area and/or crotch area both comprise at least one sensor, in particular force sensor, each.

The force sensors may in particular be in elongate form and extend over entire sections of the item of clothing, preferably in a manner invisible from the outside. In particular, at least one force sensor (preferably each of multiple force sensors) may extend over the entire length of a sleeve of an item of upper body clothing, such as for example a jacket, a coat, a pullover or a shirt. It is in particular also possible for a force sensor (preferably each of multiple force sensors) to 10 extend over a proportion of at least 30%, in particular at least 50%, quite in particular at least 70%, of the length of a sleeve of an item of upper body clothing, such as for example a jacket, a coat, a pullover or a shirt. In particular, at least one force sensor (preferably each of multiple force sensors) may extend over the entire length of a trouser leg. It is in particular also possible for a force sensor (preferably each of multiple force sensors) to extend over a proportion of at least 30%, in particular at least 50%, quite in particular at least 70%, of the length of a trouser leg. It is alternatively or additionally also advantageously possible for at least one force sensor to have a length in the range from 5 cm to 100 cm, in particular in the range from 10 cm to 50 cm. This advantageously allows the entire item of clothing to be reliably monitored for the occurrence of an emergency situation.

In particular, there may advantageously be provision for at least two force sensors to cross and/or to overlap in space. In this way, the combination of the sensor signals from the crossing and/or spatially overlapping sensors may be taken as a basis for particularly reliably detecting whether there might be an emergency situation.

Alternatively or additionally, a force sensor or multiple force sensors, in particular compressive force sensors and/or tensile force sensors, may be arranged in the back area of an item of clothing according to the invention that is for example in the form of a jacket or in the form of a pullover or in the form of a coat or in the form of trousers. In this way, it may in particular be determined whether the person wearing the item of clothing has fallen on his back or is pushed onto his back. In this case, it is advantageous in particular for determining an assault if at least one of the force sensors extends at least over a length in the range from 5 cm to 100 cm, in particular in the range from 10 cm to 50 cm.

The sensor in the form of a force sensor, in particular tensile force sensor, may comprise at least one strain gauge, for example. In the case of a strain gauge, the electrical resistance changes during expansive and compressive deformations, this being able to be detected, in particular also quantitatively, using a suitable electrical measuring circuit. In this regard, it holds that the resistance change is greater the greater the deformation.

In a quite particularly advantageous embodiment, the sensor comprises at least one textile strain gauge. By way of example, the sensor may comprise a textile element, for example a fabric strip, to which resistive ink has been applied. In particular, the resistive ink may have been sprayed on. In a particular embodiment, the resistive ink comprises particles suitable for producing a conductivity, such as for example electrically conductive carbon black or metal particles. A deformation of the textile element by way of an action of force results in a resistance change that may be measured.

In a quite particularly advantageous embodiment, the sensor comprises at least one electrically conductive and elastically stretchable thread. The thread may comprise in particular rubber and/or silicone and also additional particles for producing a conductivity, for example carbon and/or metal particles. A deformation of the electrically conductive and elastically stretchable thread by way of an action of force results in a resistance change that may be measured. In particular, a fabric may be formed from multiple such threads. Alternatively, it is also possible for single such threads to be added to an otherwise nonconductive fabric or to be connected to such a fabric.

As already mentioned, the sensor may be an acoustic sensor. In this case, there may advantageously be provision for the control apparatus to evaluate the sensor signals in respect of the occurrence of stipulated or stipulable keywords, in particular in respect of the occurrence of keywords that suggest an emergency situation. Alternatively or additionally, there may advantageously also be provision for the control apparatus to evaluate the control signals in respect of loudness. This makes use of the fact that a fight or an accident usually results in unusually loud sounds, suggesting that there is an emergency situation. In this respect, the control apparatus may advantageously be designed to transmit an emergency call and/or to establish a telecommunication connection if a predetermined or predeterminable loudness level is exceeded.

The sensor may be in the form of an optical sensor, in particular in the form of a video camera or in the form of a still camera. It is also possible for the sensor to be in the form of a simple photodiode in order to be able to detect light/dark differences. By way of example, this may suggest an emergency situation if the item of clothing is in the dark even though the wearer ought to be in the light, for example on the way home from school at lunchtime. Conversely, it would suggest an emergency situation if the item of clothing is in the light even though the wearer ought to be in the dark in the evening after sunset, for example on the way home. In this respect, the control apparatus may advantageously be designed to transmit an emergency call and/or to establish a telecommunication connection if a predetermined or predeterminable upper brightness value is exceeded and/or if a predetermined or predeterminable lower brightness value is not reached.

In a quite particularly advantageous embodiment, the control apparatus performs automatic location identification, which may in particular also comprise a comparison of images, in order to determine whether the person wearing the item of clothing is at a location that is usual for this person, for example at the children's daycare center or at school or on the way to school, or at an unknown location, which might suggest that there is an emergency situation. If the optical sensor detects that the person wearing the item of clothing is not at a location that is usual for this person, an emergency call is transmitted or a telecommunication connection is established, provided that the abort signal is not triggered.

In a quite particularly advantageous embodiment, the sensor is in the form of a position sensor, in particular in the form of a GPS module. In this case, there may advantageously be provision for the control apparatus to compare a position ascertained by means of the position sensor with at least one setpoint position. By way of example, the control apparatus may comprise a memory that stores possible setpoint positions, for example the position of the residence and/or the school and/or the way to school of a person. By comparing the actual position of the person wearing the item of clothing as ascertained by means of the position sensor with the stored setpoint positions, the control apparatus is able to determine whether the person is at a location that is unusual for this person, for example as the result of an abduction. In this case, the control apparatus transmits an emergency call and/or establishes a telecommunication connection, unless the control apparatus receives, within the time delay, an abort signal triggerable by the wearer of the item of clothing.

The sensor may, alternatively or additionally, be in the form of a speed sensor. This may be realized for example by virtue of the control apparatus continually determining the change in the positions ascertained using a position sensor over time and using it to ascertain the current speed of the person wearing the item of clothing. In this case, there may advantageously be provision for the control apparatus to transmit an emergency call or to establish a telecommunication connection if the current speed exceeds a previously stipulated or stipulable value. By way of example, an emergency situation is suggested if a child who is on foot moves at a speed above 20 km/h. In this case, the child may have been taken along in a stranger's car, for example against his will.

In a quite particularly advantageous embodiment, the sensor is in the form of an inclination sensor. Such an embodiment permits determination of whether the wearer of the item of clothing is in an unexpected or unusual position in space, such as for example after a fall.

Preferably, the sensor is arranged in a hidden and/or concealed and/or invisible manner. This advantageously prevents for example an attacker from recognizing the functionality of the item of clothing, which could lead for example to the wearer of the item of clothing being forced to remove the item of clothing. Additionally, this prevents the abort signal from being triggered by an unauthorized third party. If the item of clothing comprises multiple sensors, in particular multiple sensors of different type, there is provision for all of the sensors to be arranged in a hidden and/or concealed and/or invisible manner.

Quite generally, it is of particular advantage if the item of clothing according to the invention comprises multiple sensors, in particular multiple sensors of different type, that deliver sensor signals to a control apparatus. In particular, the item of clothing may advantageously comprise a combination of several of the sensors of different type that are described above. In this case, there may in particular advantageously be provision for the control apparatus to compare the received sensor signals from the different sensors against one another for plausibility.

It is quite generally particularly advantageous if the control apparatus continually evaluates the, in particular simultaneously obtained, sensor signals from multiple sensors of the item of clothing and attributes them either to a normal situation or to an emergency situation, in particular a criminal act. In this case, for example the sensor signals from multiple identical sensors, for example multiple force sensors arranged at different locations of the item of clothing, may be evaluated. It is, alternatively or additionally, also advantageously possible for the, preferably simultaneously captured, sensor signals from multiple different sensors, for example a force sensor and an acoustic sensor, to be evaluated. In this way, the control apparatus may take the combination of the sensor signals from multiple, in particular different and/or differently arranged, sensors as a basis for particularly reliably detecting whether there might be an emergency situation.

In particular, the control apparatus may store different sensor signal comparison patterns with which the control apparatus compares the current sensor signal from its sensor or the combination of the particular currently obtained sensor signals in order to decide whether there might be an emergency situation. For this, there may advantageously be provision for some of the stored sensor signal comparison patterns to be attributed to a normal situation while the other sensor signal comparison patterns are attributed to an emergency situation. If for example the currently obtained sensor signals correspond to a sensor signal comparison pattern that is attributed to an emergency situation, the control apparatus attributes the currently obtained sensor signals to an emergency situation and performs the further steps (in particular transmission of an emergency call with a predetermined or predeterminable time delay and/or establishment of a telecommunication connection, unless the control apparatus, within a time delay, receives an abort signal triggerable by the wearer of the item of clothing).

It is advantageously also possible for the sensor signal comparison patterns attributed to an emergency situation to have associated additional detail information about the type of emergency situation, such as for example assault or abduction or accident. By way of example, this detail information may advantageously be additionally transmitted by way of the emergency call if no abort signal is provided.

Preferably, the telecommunication connection is in a form such that audio signals and/or video signals may be transmitted. This allows the person with whom the telecommunication connection has been established to hear and/or see, in particular unnoticed, what is happening in the surroundings of the person wearing the item of clothing. In this case, it is particularly advantageous if the telecommunication connection is simultaneously also a data connection, for example in order to transmit position data. In particular, the telecommunication connection may be a mobile radio connection.

There are no fundamental restrictions in respect of the material of the item of clothing. In particular, at least part of the item of clothing may be made from cotton and/or polyester. In an advantageous embodiment, at least part of the item of clothing is made from a puncture-resistant or cut-resistant cloth. In a quite particularly advantageous embodiment, the item of clothing is in bulletproof form. These embodiments advantageously afford additional protection in the event of violent attacks.

The item of clothing may be for example in the form of a jacket, in the form of a coat, in the form of a pullover, in the form of a shirt, in the form of a smock or in the form of trousers. The item of clothing may also be in the form of a shoe. There are no fundamental restrictions in respect of the type of the item of clothing, however.

In particular, there may advantageously be provision for the at least one sensor (in particular the multiple sensors) to be arranged in the item of clothing in a manner such that it/they is/are not nondestructively removable or to be an integral part of the item of clothing. This has the particular advantage that the sensor (or the sensors) may not be accidentally or intentionally discovered and/or removed, for example by an attacker. By way of example, a cloth of the item of clothing may have been manufactured using a thread that simultaneously also acts as a sensor, for example a tensile force sensor. By way of example, there may alternatively or additionally also be provision for the at least one sensor (in particular the multiple sensors) to be arranged between an outer layer and an inner layer of the item of clothing, for example in a lining, in a manner such that it/they is/are not nondestructively removable. It is (alternatively or additionally) advantageously also possible for the at least one sensor (in particular the multiple sensors) to be fixed within the item of clothing with a force fit and/or by a material bond. By way of example, the at least one sensor may have been stitched on and/or glued on. By way of example, it is also possible for the at least one sensor to have been encapsulated, for example in the sole of a shoe.

The subject matter of the invention is shown by way of illustration and schematically in the drawing and is described below with reference to the figures, identical or identically acting elements for the most part being provided with the same reference signs even in different exemplary embodiments. In the drawing:

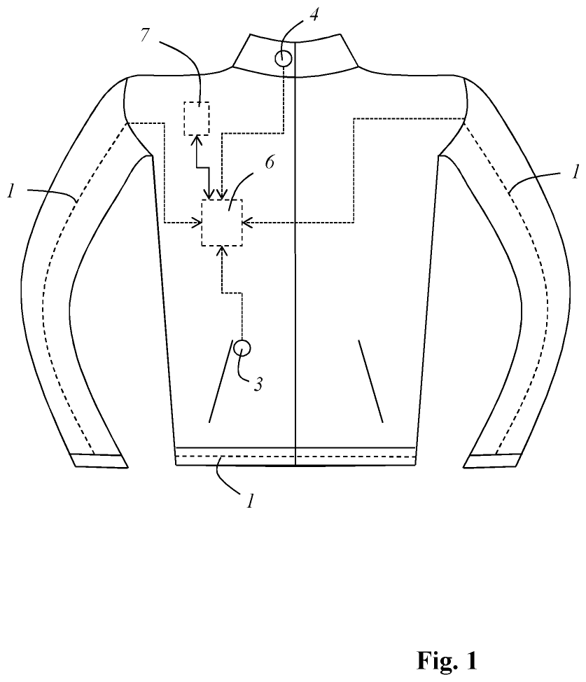

FIG. 1 shows a front view of a first exemplary embodiment of an item of clothing according to the invention,

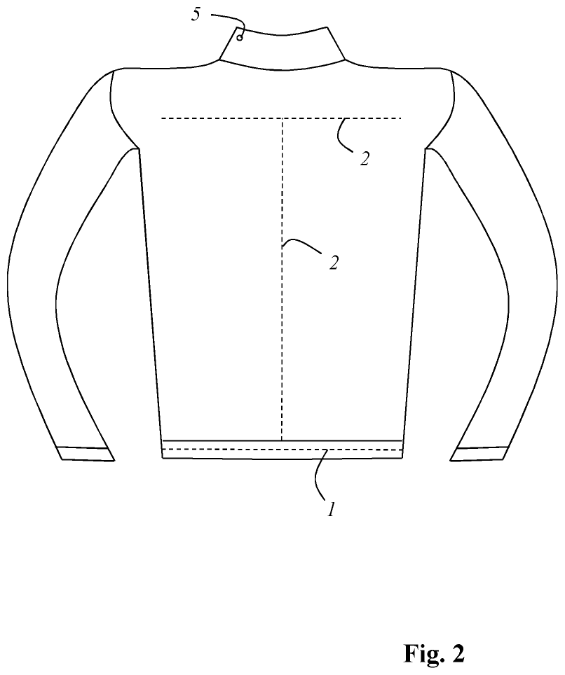

FIG. 2 shows a rear view of the first exemplary embodiment of an item of clothing according to the invention,

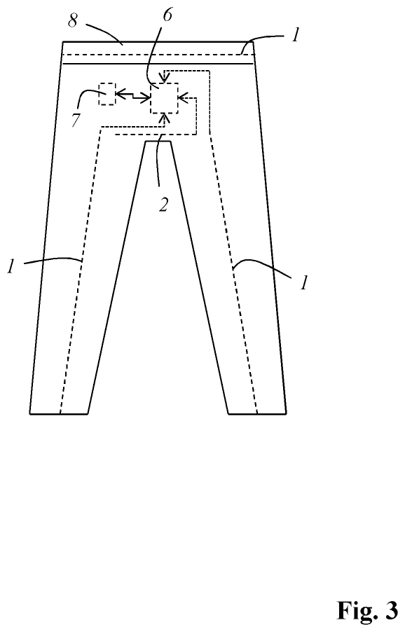

FIG. 3 shows a second exemplary embodiment of an item of clothing according to the invention, which is in the form of trousers, and

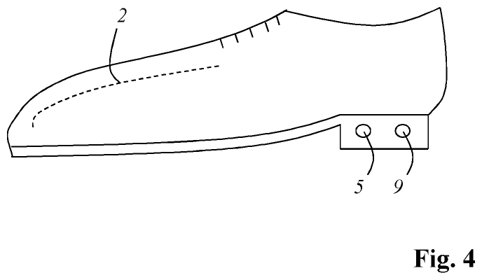

FIG. 4 shows a third exemplary embodiment of an item of clothing according to the invention, which is in the form of a shoe.

FIG. 1 shows a front view of a first exemplary embodiment of an item of clothing according to the invention, which is in the form of a jacket, while FIG. 2 shows a rear view of the exemplary embodiment.

The item of clothing comprises multiple sensors, namely tensile force sensors 1, compressive force sensors 2, an acoustic sensor 3, an optical sensor 4 and a position sensor 5, that each transmit sensor signals to a control apparatus 6. The item of clothing additionally comprises a telecommunication device 7 that is connected to the control apparatus 6 and that is designed to transmit an emergency call and/or to establish a connection. In particular, the telecommunication device 7 may be in the form of a mobile radio module, in particular in the form of a GSM module. The item of clothing may in particular also comprise an inclination sensor 9, which is not shown for the sake of better clarity, however.

The control apparatus 6 continually evaluates the sensor signals that it receives from the sensors and attributes each of them either to a normal situation or to an emergency situation. In the case of an emergency situation, the control apparatus uses the telecommunication device 7, automatically and with a time delay, to transmit an emergency call and/or to establish a telecommunication connection, for example to a cell phone. However, an emergency call is not transmitted and a telecommunication connection is not made if the control apparatus 6 receives, within the time delay, an abort signal triggerable by the wearer of the item of clothing.

The length of the time delay is adjustable. By way of example, a time delay in the range from 10 s to 1 min, in particular a time delay of 20 s, may be set.

The tensile force sensors 1 arranged in the sleeves, preferably in the inner lining of the sleeves, and in the jacket hem serve to detect tensile forces that may be due, for example, to tearing away after the wearer of the item of clothing has been grabbed by an attacker. The control apparatus 6 in this case ascertains whether forces that are above a previously stipulated tensile force value occur at the tensile force sensors 1.

The compressive force sensors 2 arranged in the back area of the item of clothing serve in particular to detect a fall onto the back or a situation in which the wearer of the item of clothing is pushed to the ground by an attacker. The control apparatus 6 in this case ascertains whether forces that are above a previously stipulated compressive force value occur at the compressive force sensors 2.

The acoustic sensor 3 receives sounds and generates corresponding electrical sensor signals that are transmitted to the control apparatus 6. The control apparatus 6 ascertains whether a specific preset loudness level is exceeded. If this is the case, it is assumed that there is an emergency situation and an emergency call is transmitted and/or a connection is established, provided that an abort signal is not received by the control apparatus 6 within the time delay.

The control apparatus 6 also examines the electrical sensor signals received from the acoustic sensor 3 for particular keywords, such as for example “help”. In particular, keywords that suggest bullying, sexual assaults, swear words and the like may also be identified. If this is the case, it is assumed that there is an emergency situation and an emergency call is transmitted and/or a connection is established, provided that an abort signal is not received by the control apparatus 6 within the time delay.

In an emergency, the acoustic sensor 3 and the telecommunication connection are used to transmit an audio recording of the surroundings of the item of clothing.

The acoustic sensor 3 additionally also acts as the input apparatus for inputting the abort signal. If the wearer of the item of clothing gives a previously stipulated abort password within the time delay, for example the word “abort”, an emergency call is not transmitted and a telecommunication connection is not established.

The optical sensor 4 in particular allows determination of whether a predetermined or predeterminable upper brightness value is exceeded and/or if a predetermined or predeterminable lower brightness value is not reached. In this way, it is possible to determine whether the person wearing the item of clothing is in the light even though he ought actually to be in the dark or vice versa, both of which might suggest an emergency situation.

Furthermore, the optical sensor 4 takes images of the surroundings and uses image comparison to determine whether the wearer of the item of clothing is at a location that is unusual for the wearer of the item of clothing.

In an emergency, the telecommunication connection is used to transmit a video or image recording of the surroundings of the item of clothing that has been recorded by means of the optical sensor 4, with the result that there is a high likelihood of a possible attacker also being captured in images.

The position sensor 5, which may in particular be in the form of a GPS module, continually transmits position data to the control apparatus 6. The control apparatus 6 compares the respective position ascertained by means of the position sensor with previously stored setpoint positions in order to determine whether the item of clothing is at a location that is unusual for the wearer of the item of clothing. Additionally, the control apparatus 6 continually ascertains the change in the positions ascertained using the position sensor 5 over time in order to determine the speed of the item of clothing.

If the item of clothing is at a location that is unusual for the wearer of the item of clothing and/or moves at a speed that exceeds a previously stipulated speed value, an emergency call is transmitted and/or a telecommunication connection is established, provided that the abort signal is not triggered beforehand.

If the control apparatus 6 identifies an emergency situation, it stores all the sensor signals that it receives within the delay time and sends these sensor signals together with the emergency call and/or after the telecommunication connection has been established. This provides the wearer of the item of clothing with the opportunity to notify the recipient of the emergency call and/or the remote station of the telecommunication connection of what has happened and/or what is happening.

FIG. 3 shows a second exemplary embodiment of an item of clothing according to the invention, which is in the form of trousers.

The item of clothing comprises multiple sensors, namely tensile force sensors 1 in the trouser legs and in the waistband 8 and a compressive force sensor 2 in the crotch, each of which transmits sensor signals to a control apparatus 6. The item of clothing additionally comprises a telecommunication device 7 that is connected to the control apparatus 6 and that is designed to transmit an emergency call and/or to establish a connection. In particular, the telecommunication device 7 may be in the form of a mobile radio module, in particular in the form of a GSM module. The trousers may furthermore comprise further, in particular other types of, sensors, which are not shown for the sake of better clarity, however.

FIG. 4 shows a third exemplary embodiment of an item of clothing according to the invention, which is in the form of a shoe.

The shoe comprises multiple sensors, namely a compressive force sensor 2 in the toe cap and also a position sensor 5 and an inclination sensor 9, each of which transmits sensor signals to a control apparatus 6 (which is not shown in this figure). The shoe additionally comprises a telecommunication device 7 (not shown in this figure) that is connected to the control apparatus 6 and that is designed to transmit an emergency call and/or to establish a connection.

The position sensor 5 and the inclination sensor 9 are arranged in the heel of the shoe. The telecommunication device 7 (not shown in this figure) and the control apparatus 6 (not shown in this figure) may also be arranged there.

The shoe may furthermore comprise further, in particular other types of, sensors, which are not shown for the sake of better clarity, however.

### LIST OF REFERENCE SIGNS

1 tensile force sensor
2 compressive force sensor
3 acoustic sensor
4 optical sensor
5 position sensor
6 control apparatus
7 telecommunication device
8 waistband
9 inclination sensor

What is claimed is:

1. An item of clothing that comprises at least one sensor, which delivers sensor signals to a control apparatus, and a telecommunication device, characterized in that the control apparatus continually evaluates the sensor signals and attributes them either to a normal situation or to an emergency situation, in particular a criminal act, and in that, in the event of an emergency situation, the control apparatus, automatically and with a predetermined or predeterminable time delay, uses the telecommunication device to transmit an emergency call and/or to establish a telecommunication connection, unless the control apparatus receives, within the time delay, an abort signal triggerable by the wearer of the item of clothing.

2. The item of clothing as claimed in claim 1, characterized in that an input apparatus for inputting the abort signal is present.

3. The item of clothing as claimed in claim 2, characterized in that the input apparatus is in the form of an electrical switch or in the form of an electrical pushbutton switch or in the form of a microphone or in the form of an optical sensor.

4. The item of clothing as claimed in claim 2, characterized in that the input apparatus is arranged in a concealed and/or invisible manner.

5. The item of clothing as claimed in claim 1, characterized in that the at least one sensor acts as the input apparatus.

6. The item of clothing as claimed in claim 1, characterized in that the at least one sensor is a force sensor that detects forces exerted on the item of clothing.

7. The item of clothing as claimed in claim 6, characterized in that the at least one sensor is a tensile force sensor.

8. The item of clothing as claimed in claim 6, characterized in that the at least one sensor is a compressive force sensor.

9. The item of clothing as claimed in claim 6, characterized in that the at least one sensor comprises at least one strain gauge.

10. The item of clothing as claimed in claim 6, characterized in that the at least one sensor comprises at least one textile strain gauge.

11. The item of clothing as claimed in claim 6, characterized in that the at least one sensor comprises a textile element to which resistive ink has been applied.

12. The item of clothing as claimed in claim 6, characterized in that the at least one sensor comprises at least one electrically conductive and elastically stretchable thread, in particular comprising rubber and/or silicone.

13. The item of clothing as claimed in claim 1, characterized in that the at least one sensor is an acoustic sensor.

14. The item of clothing as claimed in claim 13, characterized in that the control apparatus evaluates the sensor signals in respect of the occurrence of stipulated or stipulable keywords.

15. The item of clothing as claimed in claim 14, characterized in that the control apparatus evaluates the sensor signals in respect of loudness.

16. The item of clothing as claimed in claim 1, characterized in that the at least one sensor is an optical sensor, for example a camera.

17. The item of clothing as claimed in claim 1, characterized in that the at least one sensor is in the form of a position sensor.

18. The item of clothing as claimed in claim 17, characterized in that the control apparatus compares a position ascertained by means of the position sensor with at least one setpoint position.

19. The item of clothing as claimed in claim 1, characterized in that the sensor is in the form of a speed sensor.

20. The item of clothing as claimed in claim 1, characterized in that the at least one sensor is in the form of an inclination sensor.

21. The item of clothing as claimed in claim 1, characterized in that the at least one sensor is arranged in a hidden and/or concealed and/or invisible manner.

22. The item of clothing as claimed in claim 1, characterized in that the item of clothing comprises multiple sensors, in particular multiple sensors of different type, that deliver sensor signals to a control apparatus,

23. The item of clothing as claimed in claim 1, characterized in that the control apparatus stores the sensor signals that are received within the delay time.

24. The item of clothing as claimed in claim 23, characterized in that the control apparatus transmits the sensor signals received within the delay time after establishing a telecommunication connection.

25. The item of clothing as claimed in claim 1, characterized in that the telecommunication connection comprises an acoustic connection and/or an optical connection and/or a data connection and/or a mobile radio connection, in particular a GSM connection.

26. The item of clothing as claimed in claim 1, characterized in that at least part of the item of clothing is made from cotton and/or polyester.

27. The item of clothing as claimed in claim 1, characterized in that at least part of the item of clothing is made from a puncture-resistant or cut-resistant cloth.

28. The item of clothing as claimed in claim 1, characterized in that the item of clothing is in bulletproof form.
